(19) United States
(12) Patent Application Publication
(10) Pub. No.: US 2026/0153123 A1
(43) Pub. Date: Jun. 4, 2026

(54) ADJUSTING A BEARING PLAY OF COMPONENTS MOUNTED IN A COAXIALLY ROTATBLE MANNER

(71) Applicant: HWG Horst Weidner GmbH, Renningen (DE)

(72) Inventors: Sven BREITFELD, Aidlingen (DE); Frank WEIDNER, Gerlingen (DE)

(73) Assignee: HWG Horst Weidner GmbH, Renningen (DE)

(21) Appl. No.: 19/401,153

(22) Filed: Nov. 25, 2025

(30) Foreign Application Priority Data
Nov. 29, 2024 (DE) 102024135467.4

(51) Int. Cl. F16C 25/06

(52) U.S. Cl. CPC F16C 25/06; F16C 2229/00

(57) ABSTRACT

A device and a method adjust a bearing play of components mounted in a coaxially rotatable manner relative to one another. The device comprises a first part and a second part, wherein, after mechanical adjustment of the bearing play by an operator, a mutual relative radial rotation of the first part and the second part caused due to a pre-tension provided during the adjustment, so that the second part can move axially; or wherein the device comprises a spring nut and a pressure ring, wherein, after mechanical adjustment of the bearing play by an operator, a mutual relative radial rotation of the spring nut and the pressure ring is caused due to a pre-tension provided during the adjustment, thus causing the pressure ring to be able to move in an axial direction.

### CROSS REFERENCE TO RELATED APPLICATIONS

This patent application claims priority to and the benefit of German patent application 10 2024 135 467.4, filed on Nov. 29, 2024, which is hereby incorporated by reference in its entirety.

### TECHNICAL FIELD

This disclosure relates generally to a device and method for adjusting a bearing play of components and in particular to a device and method for adjusting a bearing play of components in a coaxially rotatable manner relative to one another.

### BACKGROUND

The disclosure is based on a device for adjusting a bearing play of components mounted in a coaxially rotatable manner relative to one another, and methods of adjusting a bearing play of components mounted in a coaxially rotatable manner relative to one another.

Devices for adjusting bearing plays have been state of the art for a long time. They typically consist of an individual adjustment along the pre-tensioning path. The desired pre-tensioning force may be adjusted via tolerance shims, intermediate rings or distance rings. This type of play adjustment is relatively complex since prior to selecting the appropriate shim or rings, the bearing play must first be measured. The only alternative option to measuring the bearing play is to try out different shims or rings, but this can be very time-consuming, as the component and bearing must be removed from the bracket or housing in which they are mounted to change the shims or rings.

The generation of a positioning force by direct means is also well known and may be done, for example, via a counterlocked adjusting nut or a counterlocked cone. In this case, the adjusting nut is pressed against the fixed ring of the roller bearing or the cone is pressed against the rolling elements and locked in position with a lock nut. Two tools are always required for this. In addition, when tightening the lock nut, the adjusting nut or cone may be turned slightly out of its set position, which changes the play again, making readjustment necessary. Another disadvantage is that the bearing play must always be adjusted before the components are fastened in the housing, bracket, fork or frame. Conversely, changing the play will always require the fastenings of the components to be loosened.

Further devices for adjusting bearing plays are known from DE 10 2005 022 808 A1, DE 199 40 969 A1, US 2017/0254361 A1, U.S. Pat. Nos. 4,531,756 A, 4,573,698 A and JP S58-132765 U.

WO 2016/029896 A1 also discloses a ring (threaded ring) operatively connected to a roller bearing and a ring (pressure ring) operatively connected to an abutment, wherein both rings are mounted so as to be rotatable relative to one another about an axis of rotation and have each a contact surface for mutual engagement of the two rings, which has an axial pitch in a direction of rotation of the ring operatively connected to the roller bearing against the ring operatively connected to the abutment, so that the total axial height of the two rings lying against each other at the contact surface can be changed by rotating the two rings relative to one another, and the two rings can be locked together in different angular positions along their contact surface over an adjustment angle during their relative movement about the axis of rotation, wherein the locking is releasable. The advantage here is that the play can be adjusted not only in a pre-assembled state, but also with all components in a functional, i.e. ready-to-use or ready-to-drive, arrangement. However, the disadvantage here is that the device is very heavy.

### SUMMARY

It is therefore an object of the disclosure to provide a device for adjusting a bearing play of components mounted in a coaxially rotatable manner relative to one another that overcomes the disadvantages of the state of the art and to provide a method of adjusting a bearing play of components mounted in a coaxially rotatable manner relative to one another that overcomes the disadvantages of the state of the art.

An exemplary inventive device for adjusting a bearing play of components mounted in a coaxially rotatable manner relative to one another and an exemplary inventive method of adjusting a bearing play of components mounted in a coaxially rotatable manner relative to one another have the advantage over the state of the art that the device for adjusting the bearing play of components mounted in a coaxially rotatable manner relative to one another which are connected to each other in a rotatable manner via at least two bearings (e.g. rolling bearings) arranged at an axial distance from one another, wherein one component is received in an accommodation recess, for example a housing, a bracket, a vehicle frame or a vehicle fork, has a side that can be, in a direct or indirect manner, connected coaxially to one of the two bearings and exert axial pressure on one of the bearings, wherein the device includes a first part provided with an opening and having a side, and a second part, which are arranged coaxially on the component connected to the accommodation recess, wherein the second part has a side with at least one contour protruding from the plane of the end face, wherein the second part protrudes at least partially into the opening of the first part so that the side at least partially contacts a stop surface of the first part located in the opening which has a contour protruding from the plane of the stop surface, wherein at least one of the contours is provided with a slope on which the at least one opposite contour slides, and wherein means are provided on the first part and the second part for mutual radial rotation as a result of which the second part moves axially in the direction of the bearing, and means for locking the axially moving second part in the axial position it has assumed, which makes it possible to achieve a device that allows play adjustment not only in a pre-assembled state but also when all components are ready for operation, i.e. ready for use or ready to drive, which is very compact in design. According to an example of the inventive device, a torsion spring is provided for mutual radial rotation of the first part and the second part, which spring has a first stop that at least partially protrudes into an accommodation recess, preferably a slot, arranged on the second part, and has a second stop that protrudes at least partially into a recess arranged on the first part, and an adjusting element, for locking the second part, protrudes into the recess essentially tangentially or slightly obliquely, which adjusting element can be moved towards and locked against the second stop, or, for mutual radial rotation of the first part and the second part, one of the two parts has a stop element protruding axially from its end face and the other part has a recess into which the stop element protrudes, wherein an adjusting element protrudes into this recess essentially tangentially or slightly obliquely, which adjusting element can be moved towards and locked against the stop element. Preferably, the part operatively connected to the rolling bearing has the stop element protruding axially from its end face. Accordingly, it is the opposite part which is in operative connection with the abutment that is equipped with the adjusting mechanism. For this purpose, the latter part has a recess into which the stop element of the part operatively connected to the roller bearing protrudes. Regardless of whether the recess is located on the first part or the second part, the recess is preferably extended in the circumferential direction of the part, with the adjusting element protruding into this recess essentially tangentially or slightly obliquely, so that it can be moved towards and locked against the stop element located on the other part. This means that the part equipped with the adjustment mechanism is further away from the bearing, making it easier to access with a tool to adjust the bearing play.

According to an advantageous configuration of the inventive device, if a torsion spring is present, the torsion spring has a first leg directed at least partially towards the accommodating recess and a second leg directed at least partially towards the accommodating recess, with the first leg at least partially forming the first stop and/or the second leg at least partially forming the second stop, or, if a stop element is present, the stop element is in the form of a pin. The use of a pin enables a space-saving and compact design. Preferably, the first leg is at least partially directed inwards and the second leg is at least partially directed outwards.

According to an additional advantageous configuration of the inventive device, if a torsion spring is present, its first leg, which at least partially forms the first stop, is secured by an axial locking device.

According to an additional advantageous configuration of the inventive device, the axial locking device is arranged on the side of the first part and has a raised portion which protrudes at least partially into the recess, or the axial locking device is a groove arranged in the recess into which the first leg protrudes at least partially, or the axial locking device is a slot arranged on the recess through which the first leg protrudes at least partially.

According to an additional advantageous configuration of the inventive device, the adjusting element is a set screw. The use of a set screw enables a space-saving and compact design. Preferably, the set screw is made of a polymer material.

According to a pertinent advantageous configuration of the inventive device, the shape of the milling corresponds to that of the set screw has a self-locking thread. The set screw is preferably made of a polymer material, which allows it to be easily formed with a self-locking thread, eliminating the need for additional locking of the adjusting screw.

According to an additional advantageous configuration of the inventive device, the first part and/or the second part are made at least partially of a polymer material. This means that the adjustment device can be manufactured cost-effectively, particularly by injection moulding. According to an additional advantageous configuration of the inventive device, the second part that, in the assembled state, faces away from the bearing is arranged on the component connected to the accommodation recess in an axially movable manner, with the second part having an end face that is applied to the accommodation recess of this component, with the accommodation recess forming an abutment for this second part. According to an advantageous configuration of the inventive method of adjusting a bearing play of components mounted in a coaxially rotatable manner relative to one another which are connected to each other by at least two bearings (e.g. rolling bearings) arranged at an axial distance from each other the device for adjusting the bearing play of components mounted in a coaxially rotatable manner relative to one another which are connected to each other in a rotatable manner via at least two bearings (e.g. rolling bearings) arranged at an axial distance from each other, wherein one component is received in an accommodation recess, for example a housing, a bracket, a vehicle frame or a vehicle fork, and wherein the device has a side that can be, in a direct or indirect manner, operatively connected coaxially to one of the two bearings and exert axial pressure on one of the bearings, wherein the device includes a first part provided with an opening and having a side, and a second part, which are arranged coaxially on the component connected to the accommodation recess, wherein the second part has a side with at least one contour protruding from the plane of the end face, wherein the second part protrudes at least partially into the opening of the first part so that the side at least partially contacts a stop surface of the first part located in the opening which has a contour protruding from the plane of the stop surface, wherein at least one of the contours is provided with a slope on which the at least one opposite contour slides, and wherein means are provided on the first part and the second part for mutual radial rotation as a result of which the second part moves axially in the direction of the bearing, and means for locking the axially moving second part in the axial position taken, wherein, after mechanical adjustment of the bearing play by an operator, a mutual relative radial rotation of the first part and the second part is effected due to a pre-tension provided during adjustment, causing the second part to move axially, the axial movement of the second part causes automatic self-adjustment of the bearing play.

The inventive device for adjusting a bearing play of components mounted in a coaxially rotatable manner relative to one another and the inventive method of adjusting a bearing play of components mounted in a coaxially rotatable manner relative to one another may have the advantage over the state of the art that the device for adjusting the bearing play of components mounted in a coaxially rotatable manner relative to one another which are connected to each other in a rotatable manner via at least two bearings (e.g. rolling bearings) arranged at an axial distance from one another, wherein one component is received in an accommodation recess, for example a housing, a bracket, a vehicle frame or a vehicle fork, has a side that can be, in a direct or indirect manner, connected coaxially to one of the two bearings and exert axial pressure on one of the bearings, wherein the device comprises a spring nut, a torsion spring having a leg and a leg and a pressure ring, wherein the spring nut has at least one opening on one side for at least partially receiving the leg, which is preferably aligned perpendicular or nearly perpendicular to the side of the spring nut, or at least one engaging piece for engaging the leg, which is preferably aligned parallel or nearly parallel to the side of the spring nut, and the pressure ring has at least one opening on one side for at least partially receiving the leg, which is preferably aligned perpendicular or nearly perpendicular to the side of the pressure ring, or at least one engaging piece for engaging the leg, which is preferably aligned parallel or nearly parallel to the side of the pressure ring, is arranged coaxially on the component connected to the accommodation recess, whereby the device, which makes it possible to achieve a device that allows play adjustment not only in a pre-assembled state but also when all components are ready for operation, i.e. ready for use or ready to drive, and which is very compact in design.

According to an advantageous configuration of the inventive device, the pressure ring has an inner surface that is at least partially smooth and/or that is at least partially provided with a thread.

According to an additional advantageous configuration of the inventive device, the side of the pressure ring has at least partially at least one friction-increasing means and/or the other side of the pressure ring has at least partially at least one friction-increasing means and/or the side of the spring nut has at least partially at least one friction-increasing means. An appropriate friction-increasing means to be employed may be, for example, an at least partially rubberised surface on at least one of the sides or an at least partially rough surface on at least one of the sides. It is also conceivable that, in addition or alternatively, a friction-enhancing device, in particular a wedge lock washer, is arranged on at least one of the sides. According to an additional advantageous configuration of the inventive device, at least one opening is arranged in a groove arranged on the side of the pressure ring, which has a center point, and/or at least one opening is arranged in a groove arranged on the side of the spring nut which has a center point. It is conceivable that a groove which is arranged on one side and in which one leg of the torsion spring can be guided, forms a closed circle on said side that runs around the center point or forms a non-closed circle on said side that runs around the center point. In the case of a non-closed circle, i.e. a groove that describes a circular arc, it is conceivable that the opening is located at one end of the groove or in the middle of the circular arc and/or that the groove has an increasing depth in the direction of the opening, whereby the leg is automatically guided in the groove in the direction of the opening in order to ultimately be at least partially received by the opening. According to an exemplary method of adjusting a bearing play of components mounted in a coaxially rotatable manner relative to one another which are connected to each other in a rotatable manner via at least two bearings arranged at an axial distance from each other by means of a device for adjusting the bearing play of components mounted in a coaxially rotatable manner relative to one another, which are connected to each other in a rotatable manner via two bearings arranged at an axial distance from each other, wherein a component is received by an accommodating recess, for example a housing, a bracket, a vehicle frame or a vehicle fork, and wherein the device has a side for being, in a direct or indirect manner, operatively connected coaxially to one of the two bearings and for exerting axial pressure on one of the bearings, and wherein the device has a side for being, in a direct or indirect manner, operatively connected coaxially to one of the two bearings and for exerting axial pressure on one of the bearings, wherein the device comprises a spring nut, a torsion spring comprising a leg and a leg, and a pressure ring, wherein the spring nut has at least one opening on one side for at least partially receiving the leg or at least one engaging piece for engaging the leg, and the pressure ring has on one side has at least one opening for at least partially accommodating the leg or at least one engaging piece for engaging the leg, is arranged coaxially on the component connected to the accommodating recess, whereby, after mechanical adjustment of the bearing play by an operator, a mutual relative radial rotation of the spring nut and the pressure ring is effected due to a pre-tension provided during adjustment, the pressure ring is able to move in an axial direction, and the axial movement of the pressure ring causes automatic self-adjustment of the bearing play.

According to an additional advantageous configuration of the inventive method, a device according to dependent claims is employed as a device for adjusting the bearing play of components mounted in a coaxially rotatable manner relative to one another.

The inventive devices and methods can be advantageous when used in the adjustment of bearings of bicycle hubs, specifically front wheel hubs or rear wheel hubs. The adjustment of play is preferably performed on wheels that have already been installed and tightened in the fork or frame. Another advantage is that the device is very small, compact and lightweight, as it is arranged on the shaft between a leg of the fork or frame and an external rolling bearing and does not protrude beyond the diameter of the spoke flange.

However, the disclosure can also be advantageously employed for adjusting bearing plays of headsets or on rotating shafts, for example spindles of machine tools.

The adjustment device for a bearing play can be positioned anywhere between the abutment and one of the two rolling bearings. This allows for a certain degree of design freedom in the conception of the bearing and the layout of the entire assembly. Advantageously, the adjustment device is placed in a location that is easily accessible once the assembly has been fully assembled.

Further advantages and advantageous configurations of the disclosure may be found in the following description and in the drawings.

### BRIEF DESCRIPTION OF THE DRAWINGS

Preferred examples of the object of the disclosure are represented in the drawings and will be described hereunder in greater detail. In the drawings:

FIG. 1 is a side view of an exploded representation of various components of an exemplary device according to the disclosure for adjusting a bearing play of components mounted in a coaxially rotatable manner relative to one another,

FIG. 2 is a perspective top view of the exploded representation of an inventive device according to FIG. 1,

FIG. 3 is a perspective bottom view of an exploded representation of an inventive device according to FIG. 1,

FIG. 4 is a side view of an inventive device in an untensioned state,

FIG. 5 is another side view of the inventive device according to FIG. 4,

FIG. 6 is a top view of the inventive device according to FIG. 4,

FIG. 7 is a perspective top view of the inventive device according to FIG. 4,

FIG. 8 is a bottom view of the inventive device according to FIG. 4,

FIG. 9 is a perspective bottom view of the inventive device according to FIG. 4,

FIG. 10 is a side view of an inventive device in a tensioned state,

FIG. 11 is another side view of the inventive device according to FIG. 10,

FIG. 12 is a top view of the inventive device according to FIG. 10,

FIG. 13 is a perspective top view of the inventive device according to FIG. 10,

FIG. 14 is a bottom view of the inventive device according to FIG. 10,

FIG. 15 is a perspective bottom view of the inventive device according to FIG. 10,

FIG. 16 is an exploded representation of a headset of a bicycle,

FIG. 17 is a perspective bottom view of an exploded representation of the headset according to FIG. 16,

FIG. 18 is a side view of the headset according to FIG. 16,

FIG. 19 is a sectional view of the headset according to FIG. 16,

FIG. 20 is a partially represented sectional view of the headset according to FIG. 16,

FIG. 21 is a side view of an exploded representation of various components of another embodiment of an inventive device for adjusting a bearing play of components mounted in a coaxially rotatable manner relative to one another,

FIG. 22 is a perspective top view of an exploded representation of an inventive device according to FIG. 21,

FIG. 23 is a perspective bottom view of an exploded representation of an inventive device according to FIG. 21,

FIG. 24 is a side view of an inventive device in an untensioned state,

FIG. 25 is another side view of the inventive device according to FIG. 24,

FIG. 26 is a top view of the inventive device according to FIG. 24,

FIG. 27 is a perspective top view of the inventive device according to FIG. 24,

FIG. 28 is a bottom view of the inventive device according to FIG. 24,

FIG. 29 is a perspective bottom view of the inventive device according to FIG. 24,

FIG. 30 is a side view of an inventive device in a tensioned state,

FIG. 31 is another side view of the inventive device according to FIG. 30,

FIG. 32 is a top view of the inventive device according to FIG. 30,

FIG. 33 is a perspective top view of the inventive device according to FIG. 30,

FIG. 34 is a bottom view of the inventive device according to FIG. 30,

FIG. 35 is a perspective bottom view of the inventive device according to FIG. 30,

FIG. 36 is an exploded representation of a headset of a bicycle,

FIG. 37 is a perspective bottom view of an exploded representation of the headset according to FIG. 36,

FIG. 38 is a side view of the headset according to FIG. 36,

FIG. 39 is a sectional view of the headset according to FIG. 36,

FIG. 40 is a partially represented sectional view of the headset according to FIG. 36,

FIG. 41 is a side view of an exploded representation of various components of another example of an inventive device for adjusting a bearing play of components mounted in a coaxially rotatable manner relative to one another,

FIG. 42 is a perspective bottom view of an exploded representation of an inventive device according to FIG. 41,

FIG. 43 is a perspective top view of an inventive device according to FIG. 41,

FIG. 44 is a perspective bottom view of an inventive device according to FIG. 41,

FIG. 45 is a top view of the inventive device according to FIG. 41 in which the first part 1 has been omitted,

FIG. 46 is a bottom view of the inventive device according to FIG. 41 in which the second part and the pin have been omitted,

FIG. 47 is a side view of an exploded representation of various components of another example of an inventive device for adjusting a bearing play of components mounted in a coaxially rotatable manner relative to one another,

FIG. 48 is a perspective bottom view of an exploded representation of an inventive device according to FIG. 47,

FIG. 49 is a perspective top view of an exploded representation of an inventive device according to FIG. 47,

FIG. 50 is a perspective bottom view of an inventive device according to FIG. 47,

FIG. 51 is a top view of the inventive device according to FIG. 47 in which the first part has been omitted,

FIG. 52 is a bottom view of the inventive device according to FIG. 47 in which the second part has been omitted,

FIG. 53 is a top view of an example inventive device,

FIG. 54 is a bottom view of an inventive device according to FIG. 53,

FIG. 55 is a side view of the inventive device according to FIG. 53 in a tensioned state,

FIG. 56 is a perspective bottom view of an exploded representation of various components of another example of an inventive device for adjusting a bearing play of components mounted in a coaxially rotatable manner relative to one another,

FIG. 57 is a perspective bottom view of the inventive device according to FIG. 56,

FIG. 58 is another perspective bottom view of an exploded representation of the inventive device according to FIG. 56,

FIG. 59 is a perspective bottom view of the inventive device according to FIG. 58,

FIG. 60 is a top view of the inventive device according to FIG. 57,

FIG. 61 is a top view of the inventive device according to FIG. 57 in which the second part has been omitted,

FIG. 62 is a bottom view of the inventive device according to FIG. 57,

FIG. 63 is a top view of the inventive device according to FIG. 57 in which the second part has been omitted,

FIG. 64 is a side view of an exploded representation of the components of a hub, more specifically a front wheel hub or a rear wheel hub in which another example of an inventive device is employed for adjusting the bearing play,

FIG. 65 is a perspective view of the exploded representation according to FIG. 64,

FIG. 66 is a side view of an assembled hub according to FIG. 64 in an untensioned state,

FIG. 67 is a perspective view of the assembled hub according to FIG. 66 in an untensioned state,

FIG. 68 is a perspective view of the assembled hub according to FIG. 66 in an untensioned state,

FIG. 69 is a perspective view of the assembled hub according to FIG. 68 in an untensioned state, and

FIG. 70 is a view of the flow of forces between the two bearings which is represented as a black freehand line.

### DESCRIPTION

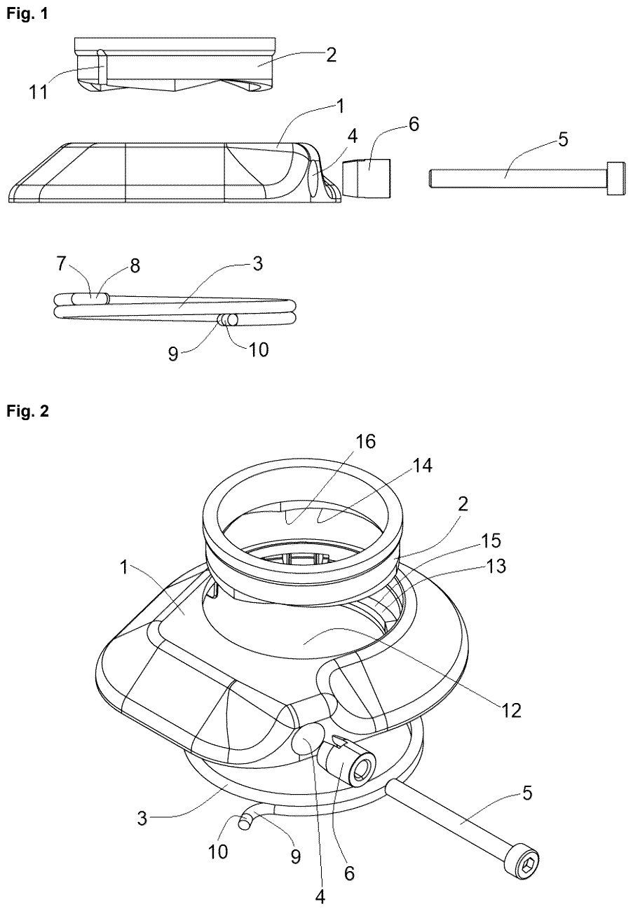

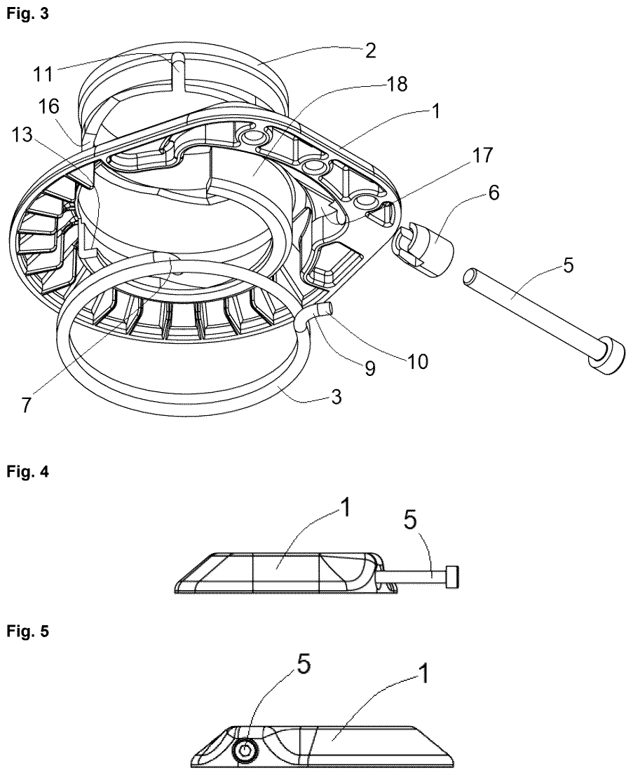

FIG. 1 shows a side view of an exploded representation of various components of a device according to the disclosure for adjusting a bearing play of components mounted in a coaxially rotatable manner relative to one another. The device according to the disclosure has a first part 1, a second part 2 and a torsion spring 3. The first part 1 has a drill hole 4 in which a threaded insert 6 may be arranged unless the drill hole 4 is itself provided with screw threads for receiving a set screw 5 or a thread-cutting screw, which is preferably made of metal, is employed. The torsion spring 3 has an inward-directed first leg 7, which at least partially forms a first stop 8, and an outward-directed second leg 9, which at least partially forms a second stop 10. When assembled, the inward-directed first leg 7 of the torsion spring 3, which at least partially forms the first stop 8, protrudes at least partially into an accommodation recess 11 which is arranged on the second part 2 and is preferably designed as a slot. FIG. 2 shows a perspective top view of an exploded representation of the inventive device according to FIG. 1, The first part 1 has an opening 12 in which a stop surface 13 is arranged. The second part 2, which has a side 14, can be inserted into the opening 12 until the side 14 touches the stop surface 13. The stop surface 13 has a contour 15 protruding from the plane of the stop surface 13. The side 14 of the second part 2 has a contour 16 protruding from the plane of the side 14. The contour 15 and the contour 16 are both provided with a slope so that the opposing contours can slide one onto the other. FIG. 3 shows a perspective bottom view of an exploded representation of an inventive device according to FIG. 1. When assembled, the outward-directed second leg 9 of the torsion spring 3, which at least partially forms the second stop 10, protrudes at least partially into an accommodation recess 17 which is arranged on the first part 1. In the assembled condition, the torsion spring 3 additionally encloses a bracket 18. The torsion spring 3 is inserted into the first part 1 from below when in an untensioned state. The second part 2 is inserted into the first part 1 from above. In this process, one end of the torsion spring 3 is hooked into the accommodation recess 11 formed in the second part 2, which is preferably a slot. In this untensioned state, the device according to the disclosure is mounted in the assembly. The second leg 9 of the torsion spring 3 protrudes in such a manner that when the set screw 5 is screwed into the threaded insert 6 located in the first part 1, it moves this second leg 9 along a screw-in axis. This causes the torsion spring 3 to twist around its vertical axis and become pre-tensioned. Thus, a pre-tensioning force is applied. The torque resulting therefrom acts on the second part 2, which rotates around its vertical axis when play occurs. The ramps (contour 15, contour 16) formed on the first part 1 and the second part 2 provide additional axial movement of the second part 2 and compensate for this play.

The relationship between pre-tensioning force and setting behaviour can be described as follows: The purpose of the pre-tensioning system is to apply an axial pre-tensioning force to the system (headset bearing) and to compensate for any settlement behaviour of the components. The term ‘settlement behaviour’ refers to a decrease in the internal stress of the material over time when a force acts on a plastic component. The two physical effects involved here are retardation and relaxation, colloquially referred to as “creep”. The pre-tensioning system must therefore be subjected to increased pre-tensioning during installation. If, for example, a torsion spring 3 is pre-tensioned by a quarter turn during installation, i.e. by 25/100 turns, this results in an axial pre-tension of 100 N. A settlement behaviour occurring in the components of the headset over time will thus result in an axial reduction in dimension of 0.1 mm, for example. To compensate for this movement, the spring must be re-adjusted/rotated by 2/100 turns. The remaining pre-tension is thus 23/100 turns. The axial pre-tension thus drops to 92 N. If an operating range of 80 N to 100 N is desired, this results in maximum compensation for the settling behaviour. In the numerical example given, this is approximately 0.25 mm.

FIG. 4 shows a side view of a device 1 according to the disclosure in an untensioned state.

FIG. 5 shows another side view of the inventive device according to FIG. 4.

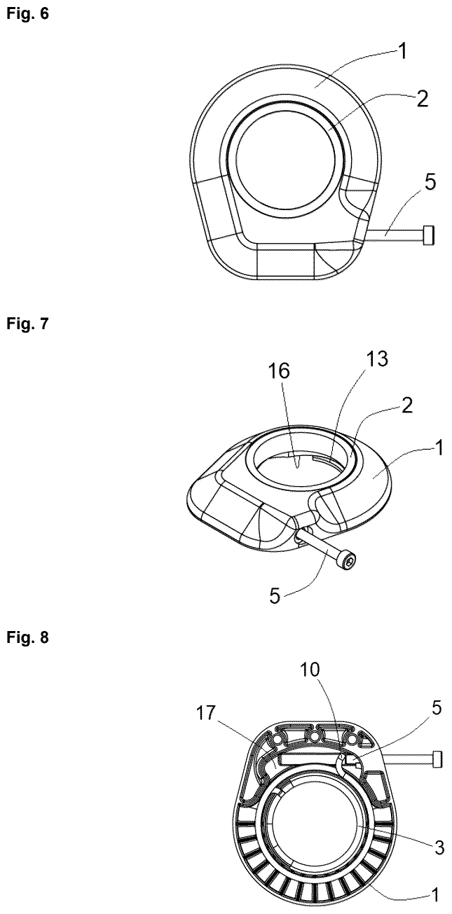

FIG. 6 shows a top view of the inventive device according to FIG. 4.

FIG. 7 shows a perspective top view of the inventive device according to FIG. 4.

FIG. 8 shows a bottom view of the inventive device according to FIG. 4.

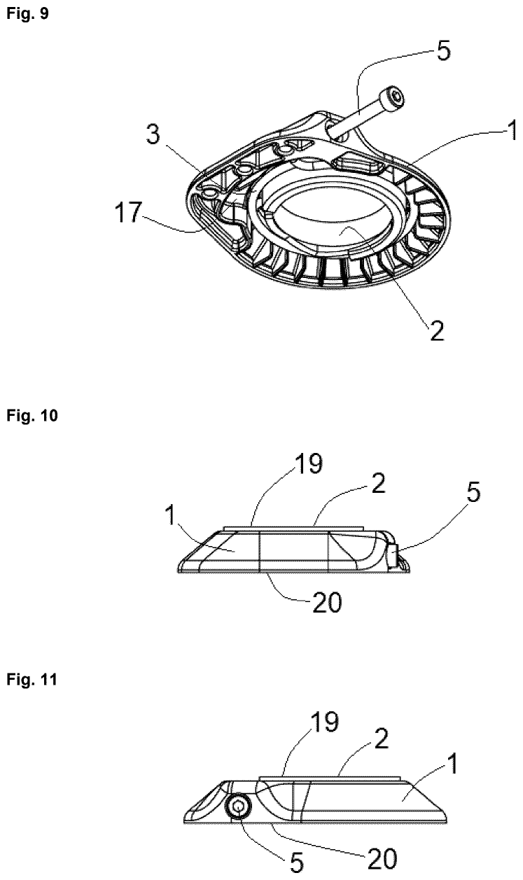

FIG. 9 shows a perspective bottom view of the inventive device according to FIG. 4.

FIG. 10 shows a side view of an inventive device in a tensioned state. The inventive device has a side 19 formed on the second part 2 and a side 20 formed on the first part 1.

FIG. 11 shows another side view of the inventive device according to FIG. 10.

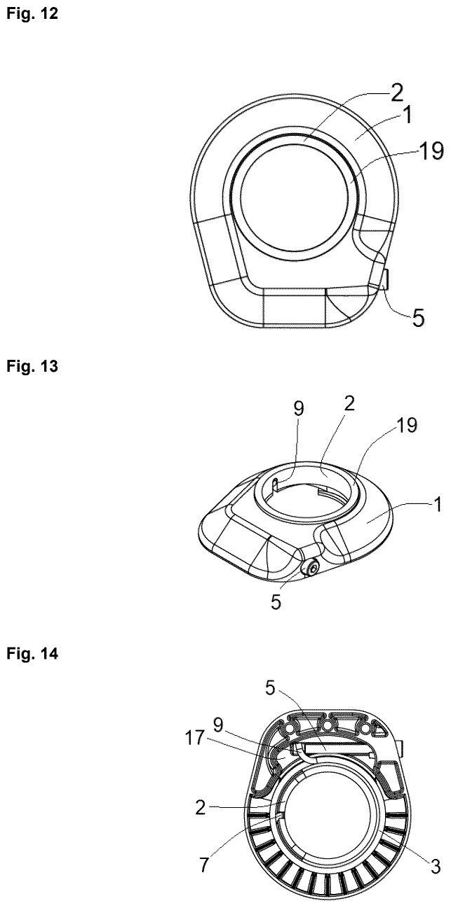

FIG. 12 shows a top view of the inventive device according to FIG. 10.

FIG. 13 shows a perspective top view of the inventive device according to FIG. 10.

FIG. 14 shows a bottom view of the inventive device according to FIG. 10.

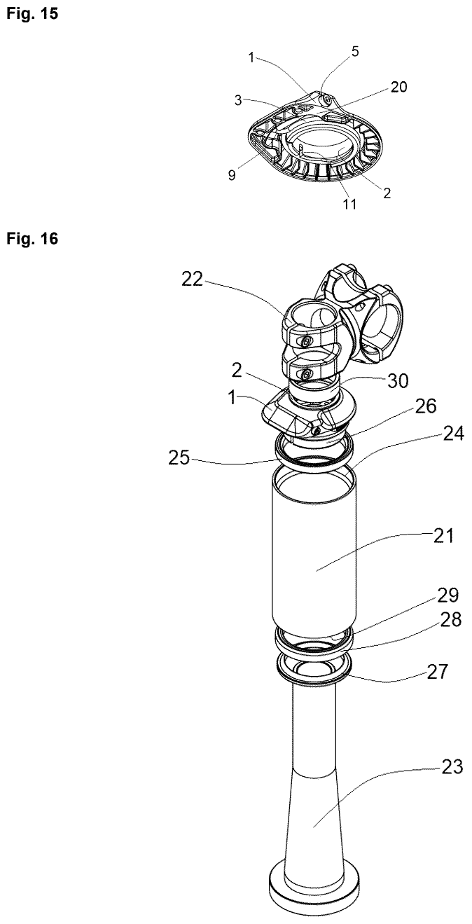

FIG. 15 shows a perspective bottom view of the inventive device according to FIG. 10.

FIG. 16 shows an exploded representation of a headset of a bicycle. The headset is installed in a head tube 21 of a non-illustrated frame of a vehicle and comprises in a known manner an upper steering head bearing arranged below a stem 22 of a handlebar of the vehicle in the head tube 21, and a lower steering head bearing arranged above the equally non-illustrated fork of the vehicle which has a fork shaft 23. The upper steering head bearing has an upper bearing shell 24 with a bearing 25 (upper rolling bearing, angular contact ball bearing) which is mounted within the head tube 21 by a clamping ring 26 (centring ring). The lower steering head bearing comprises a bottom 27 struck onto the fork shaft 23, a lower bearing 28 (lower rolling bearing, angular contact ball bearing) supported by the bottom 27, and a lower bearing shell 29 into which the lower bearing 28 and outer ring are pressed. The lower bearing shell 29 is pressed into the lower opening of the head tube 21). The fork shaft 23 is passed through an inner ring of the lower bearing 28 and through the inner ring of the upper bearing 25 and protrudes right into the upper clamping ring 26. A non-illustrated clamping claw is struck into the upper opening of the fork shaft and transmits the steering torque applied by the bicycle rider to the fork via the handlebar stem 22. The handlebar stem 22 is spaced apart from the inventive device by a spacer 30. The head tube 21 is covered by a non-illustrated cover (spacer). The handlebar stem 22 is fixedly connected to the fork shaft 23 and rotatably connected with no play to the head tube 21 by means of a non-illustrated clamping cap and a non-illustrated adjustment screw.

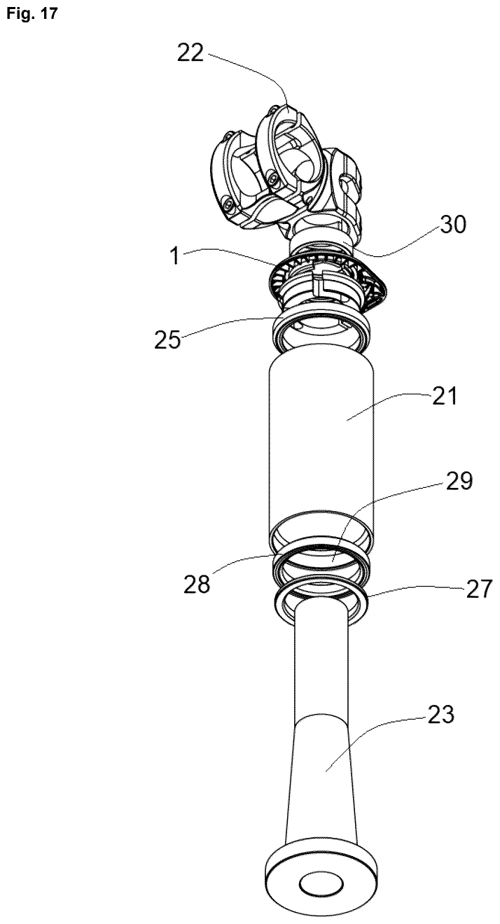

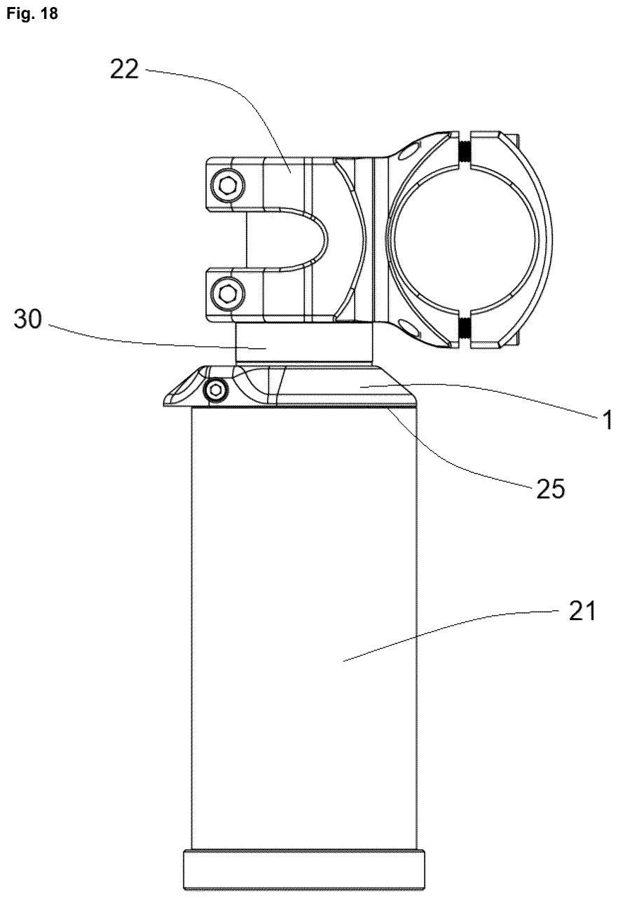

FIG. 17 shows a perspective bottom view of an exploded representation of the headset according to FIG. 16. In an assembled condition, the side 20 of the first part 1 is in a directly coaxial, operative connection with the bearing 25, thereby exerting axial pressure on the bearing 25.

FIG. 18 shows a side view of the headset according to FIG. 16.

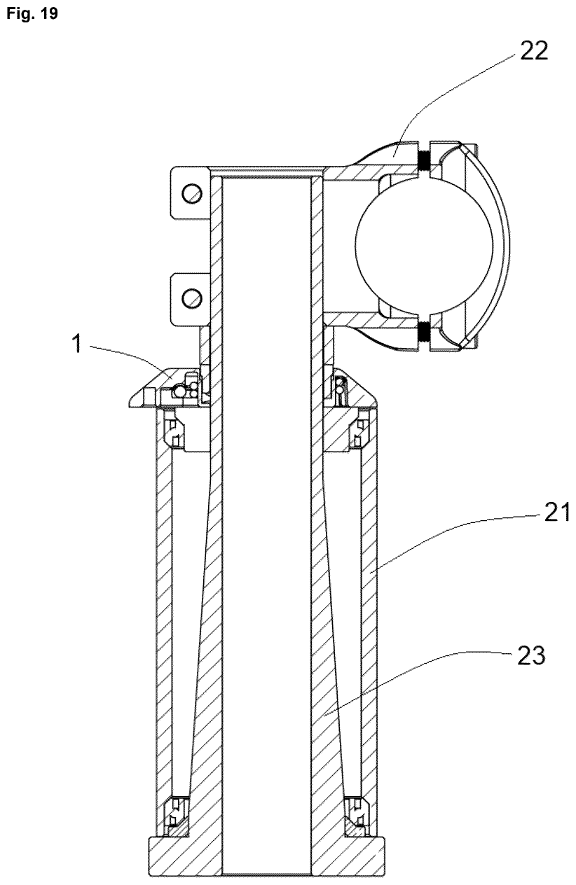

FIG. 19 shows a sectional view of the headset according to FIG. 16.

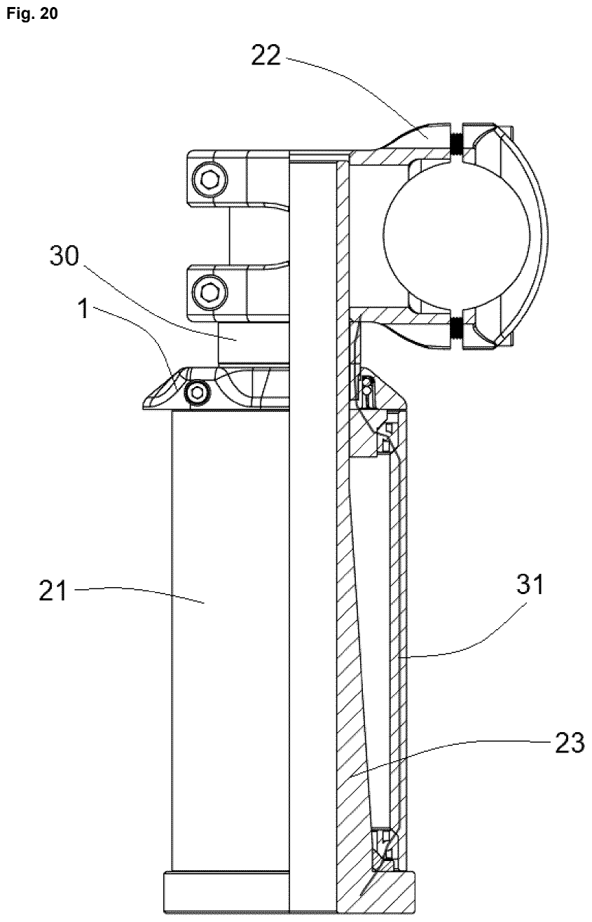

FIG. 20 shows a partially represented sectional view of the headset according to FIG. 16. A flow of forces 31 between upper bearing 25 and lower bearing 28 is represented as a black freehand line.

FIG. 21 shows a side view of an exploded representation of various components of another implementation of an inventive device for adjusting a bearing play of components mounted in a coaxially rotatable manner relative to one another. In this example, the first part 1 has an underside 32 on which a cover 33 can be arranged.

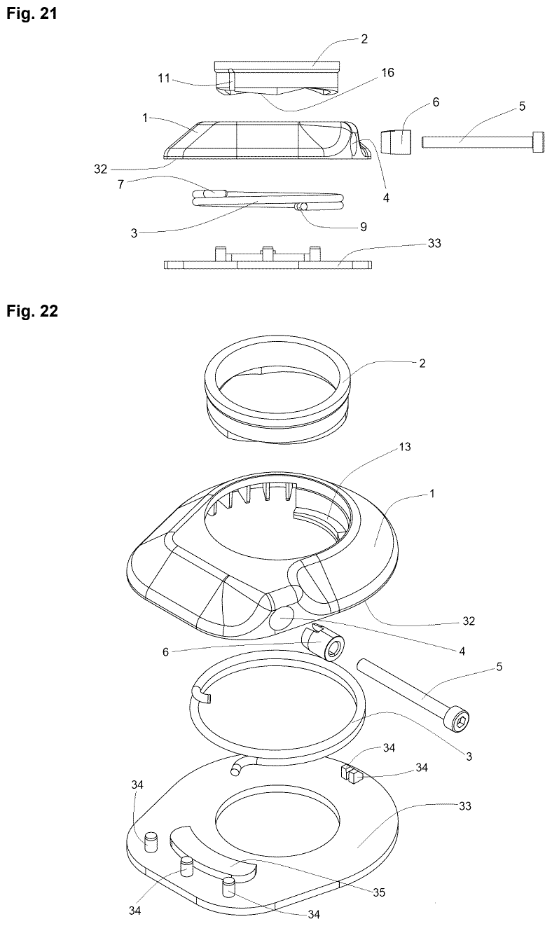

FIG. 22 shows a perspective top view of an exploded representation of the inventive device according to FIG. 21. To allow for an arrangement of the cover 33 on the first part 1, the cover 33 has pins 34 of different designs that are inserted into the first component 1. A spring retainer 35 is shaped such that it protrudes into the recess 17 to secure the second leg 9 of the torsion spring 3 therein.

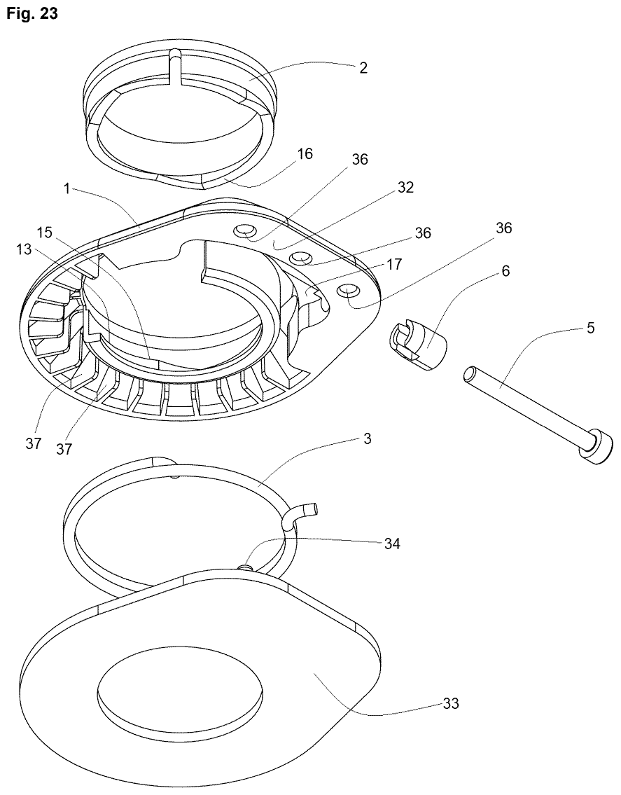

FIG. 23 shows a perspective bottom view of an exploded representation of an inventive device according to FIG. 21. The pins 34 can be inserted into openings 36 arranged on the first part 1 and/or surround walls 37 arranged on the first part 1.

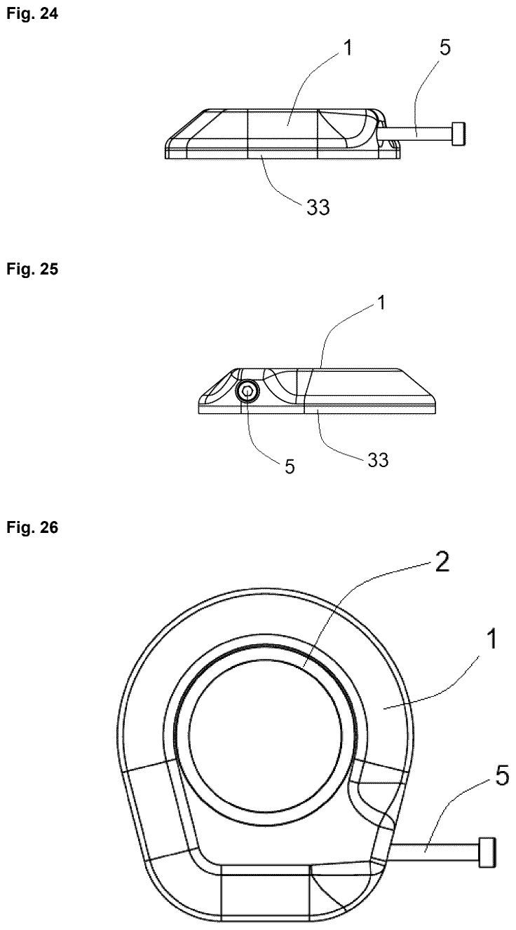

FIG. 24 shows a side view of an example of an inventive device 1 in an untensioned state.

FIG. 25 shows another side view of the inventive device according to FIG. 24.

FIG. 26 shows a top view of the inventive device according to FIG. 24.

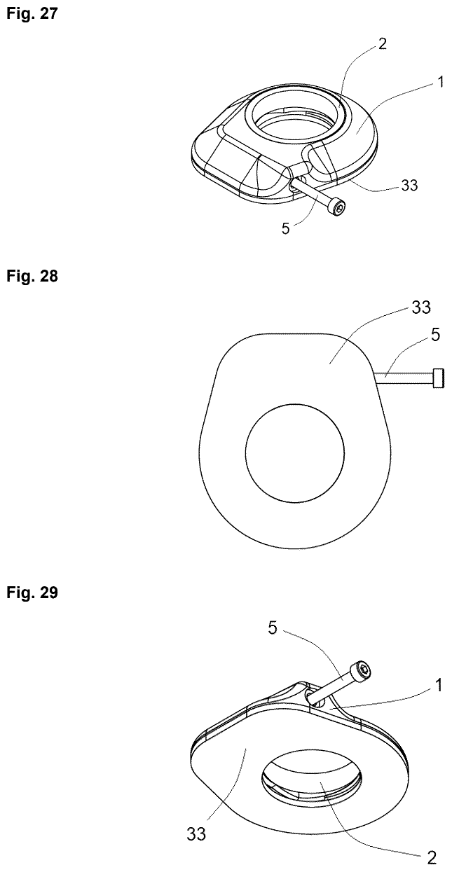

FIG. 27 shows a perspective top view of the inventive device according to FIG. 24.

FIG. 28 shows a bottom view of the inventive device according to FIG. 24.

FIG. 29 shows a perspective bottom view of the inventive device according to FIG. 24.

FIG. 30 shows a side view of an example of inventive device in a tensioned state.

FIG. 31 shows another side view of the inventive device according to FIG. 30.

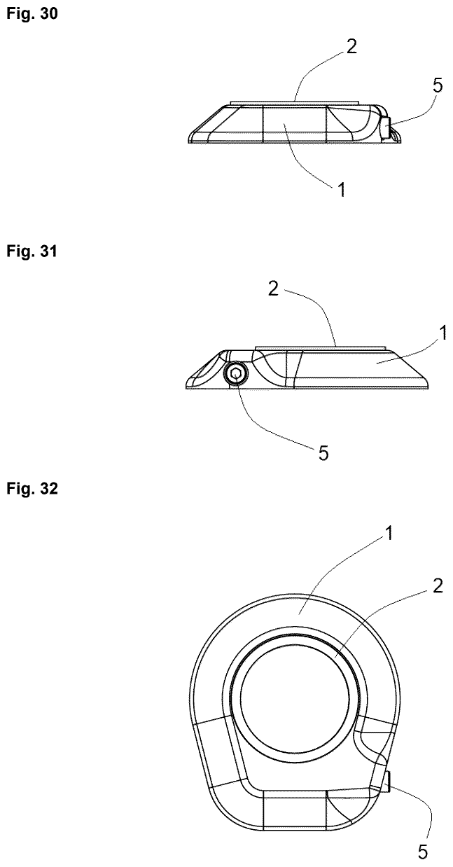

FIG. 32 shows a top view of the inventive device according to FIG. 30.

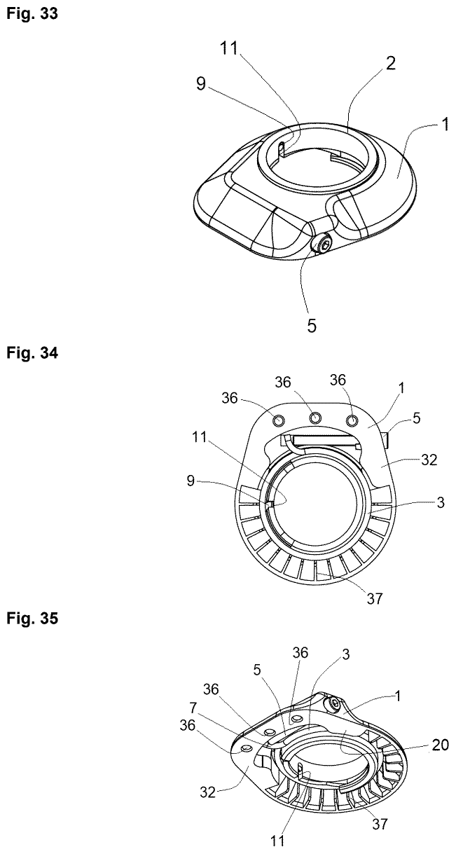

FIG. 33 shows a perspective top view of the inventive device according to FIG. 30.

FIG. 34 shows a bottom view of the inventive device according to FIG. 30.

FIG. 35 shows a perspective bottom view of the inventive device according to FIG. 30.

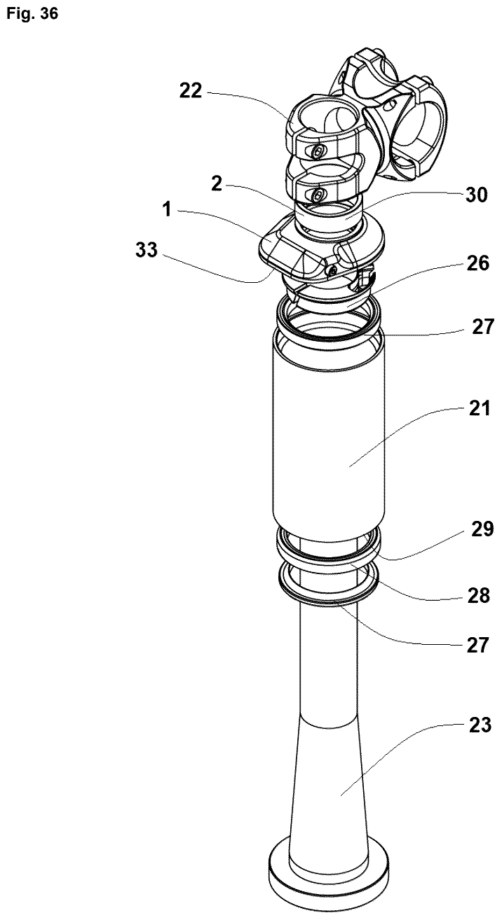

FIG. 36 shows an exploded representation of an example headset of a bicycle.

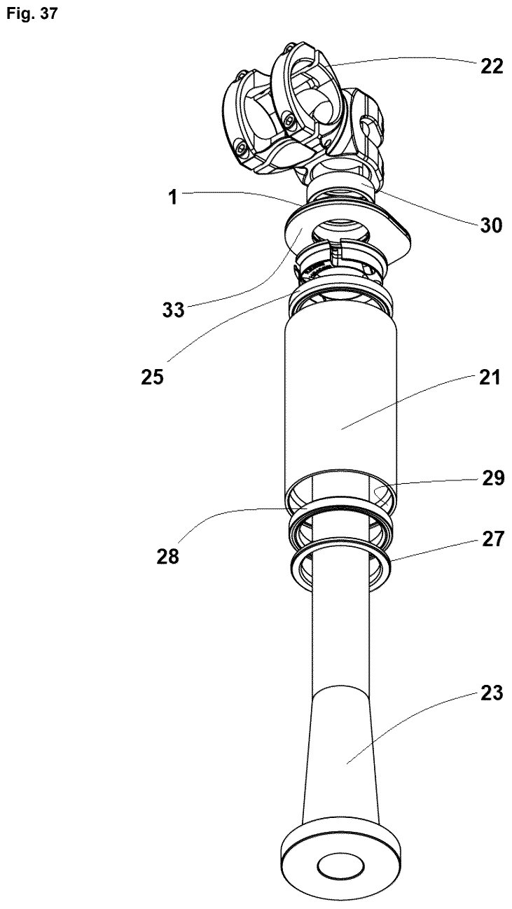

FIG. 37 shows a perspective bottom view of an exploded representation of the headset according to FIG. 36.

FIG. 38 shows a side view of the headset according to FIG. 36.

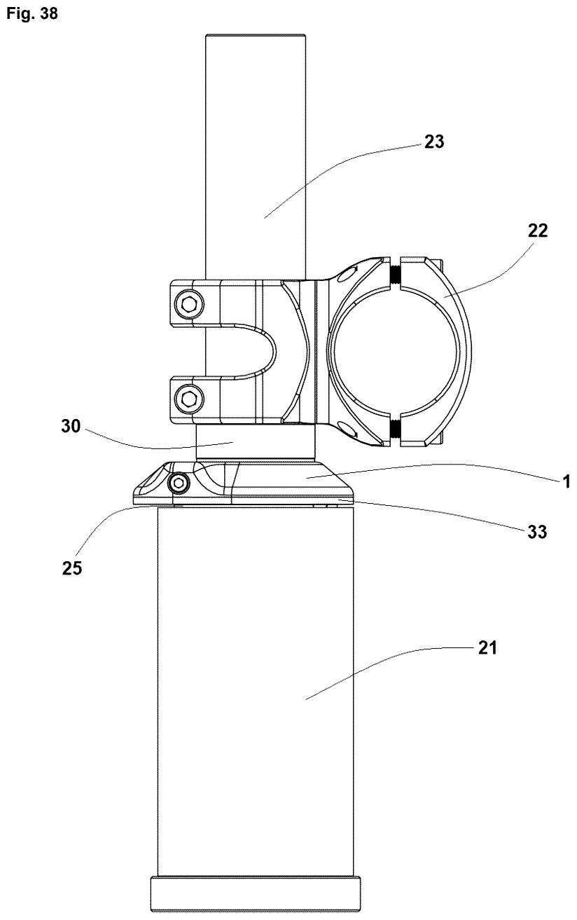

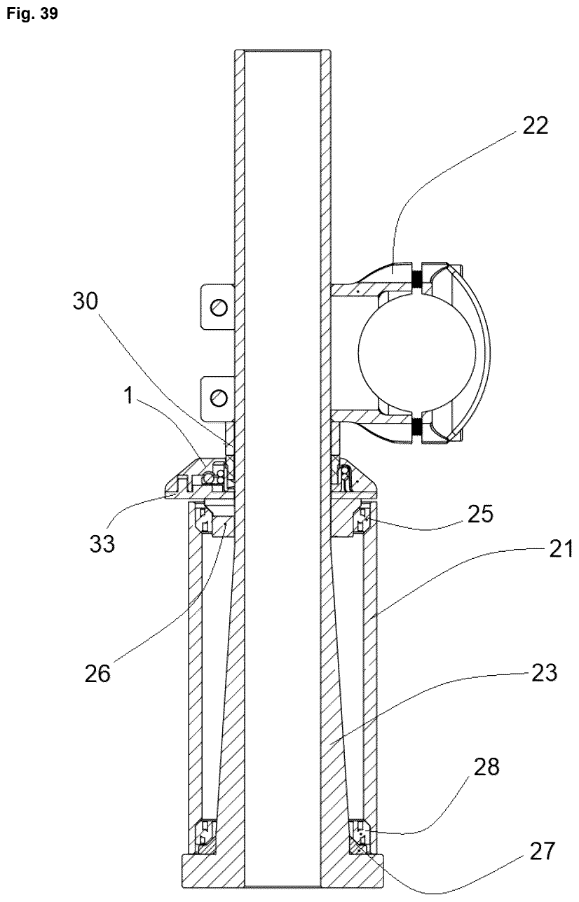

FIG. 39 shows a sectional view of the headset according to FIG. 36.

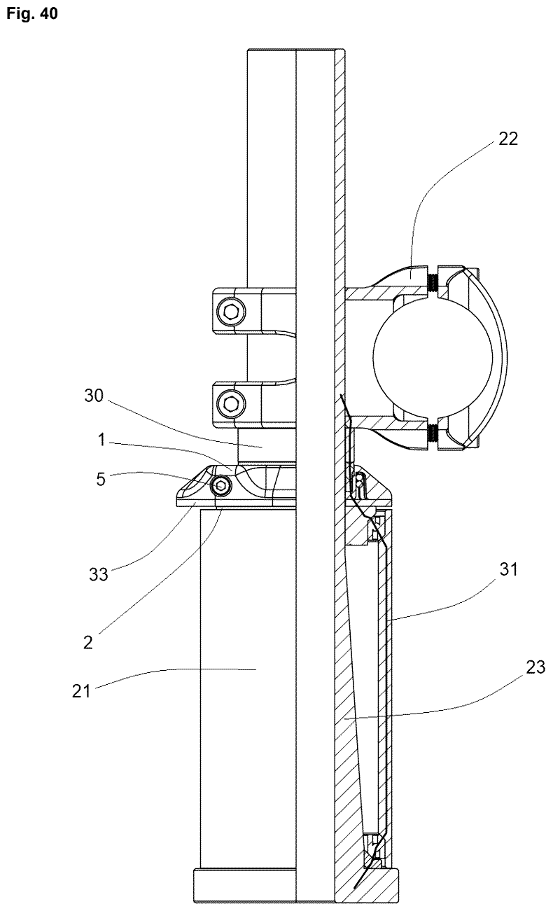

FIG. 40 shows a partially represented sectional view of the headset according to FIG. 36.

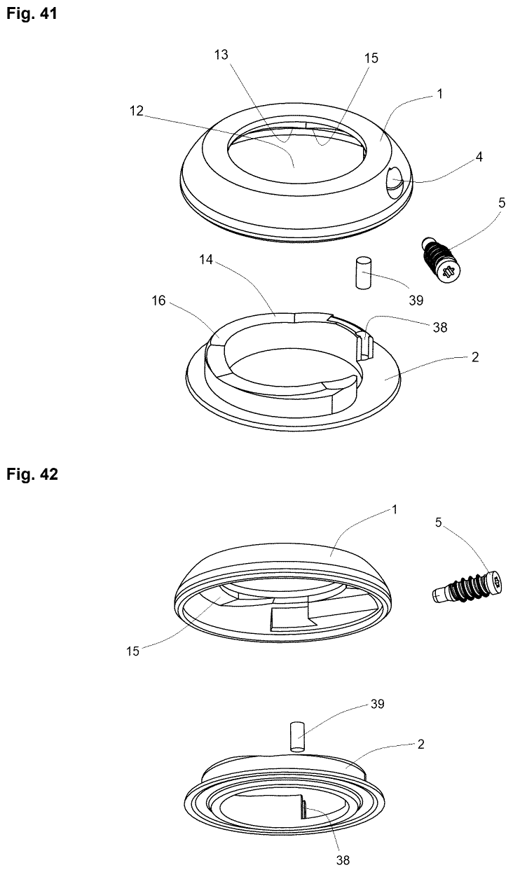

FIG. 41 shows a side view of an exploded representation of various components of another implementation of an inventive device for adjusting a bearing play of components mounted in a coaxially rotatable manner relative to one another. In this example, the second part 2 has an opening 38 into which a pin 39 can be inserted. The first part 1 has a drill hole 4 in which a non-illustrated threaded insert 6 may be arranged unless the drill hole 4 is itself provided with screw threads for receiving a set screw 5.

The first part 1 has an opening 12 in which a stop surface 13 is arranged. The second part 2, which has a side 14, can be inserted into the opening 12 until the side 14 touches the stop surface 13. The stop surface 13 has a contour 15 protruding from the plane of the stop surface 13. The side 14 of the second part 2 has a contour 16 protruding from the plane of the side 14. The contour 15 and the contour 16 are both provided with a slope so that the opposing contours can slide one onto the other.

Once assembled, the inventive device is mounted into the assembly in an untensioned state. The pin 39 positioned in the opening 38 is displaced along a screw-in axis to apply a pre-tensioning force when the set screw 5 is screwed into the first part 1. Thus, a pre-tensioning force is applied. The torque resulting therefrom acts on the second part 2, which rotates around its vertical axis when play occurs. The ramps (contour 15, contour 16) formed on the first part 1 and the second part 2 provide additional axial movement of the second part 2 and compensate for this play.

FIG. 42 shows a perspective bottom view of an exploded representation of an example of inventive device according to FIG. 41.

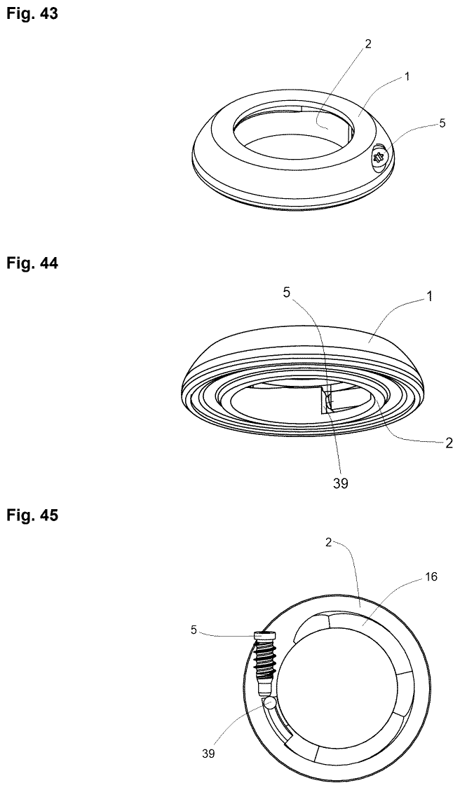

FIG. 43 shows a perspective top view of an exploded representation of the inventive device according to FIG. 41.

FIG. 44 shows a perspective bottom view of an inventive device according to FIG. 41.

FIG. 45 shows a top view of the inventive device according to FIG. 41 in which the first part 1 has been omitted.

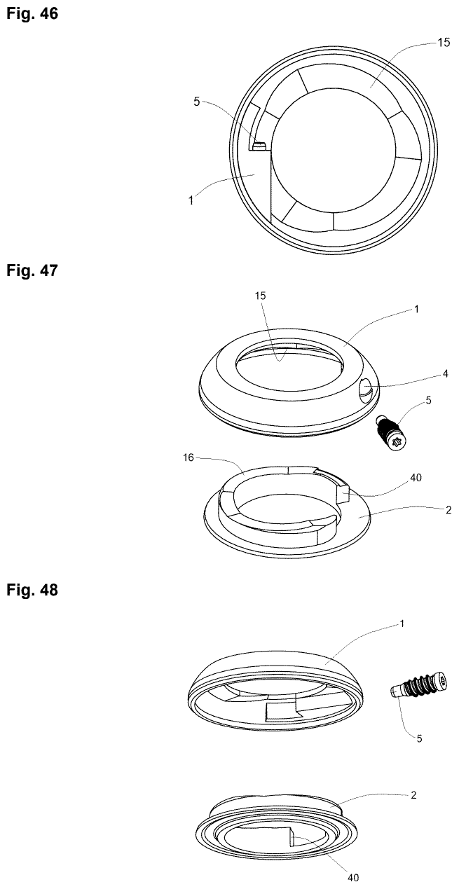

FIG. 46 shows a bottom view of the inventive device according to FIG. 41, in which the second part 2 and the pin 39 have been omitted.

FIG. 47 shows a side view of an exploded representation of various components of another implementation of an inventive device for adjusting a bearing play of components mounted in a coaxially rotatable manner relative to one another.

FIG. 48 shows a perspective bottom view of an exploded representation of an inventive device according to FIG. 47. Unlike the example represented in FIG. 41, this example has no pin 39, such that for applying the pre-tensioning force, a stop 40 located on the second part 2 is displaced along a screw-in axis when the set screw 5 is screwed into the first part 1.

FIG. 49 shows a perspective top view of an exploded representation of the inventive device according to FIG. 47.

FIG. 50 shows a perspective bottom view of an inventive device according to FIG. 47.

FIG. 51 shows a top view of the inventive device according to FIG. 47 in which the first part 1 has been omitted.

FIG. 52 shows a bottom view of the inventive device according to FIG. 47 in which the second part 2 has been omitted.

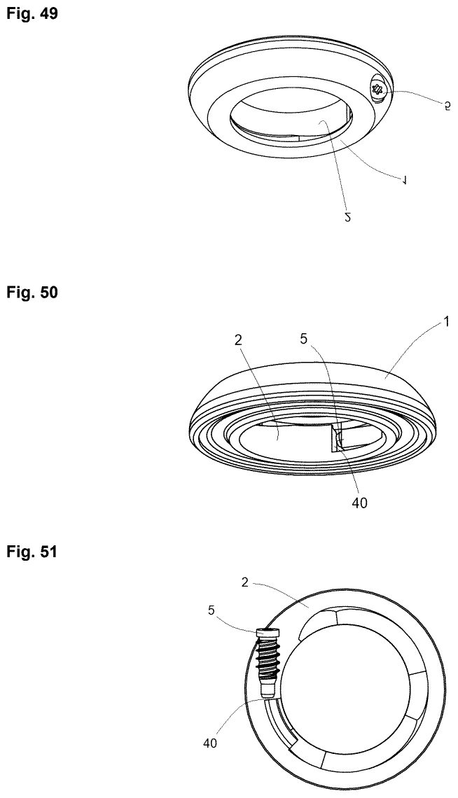

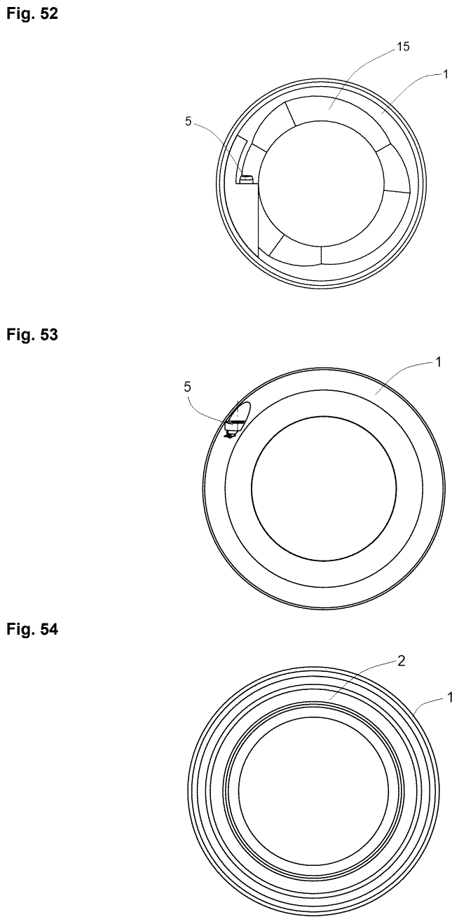

FIG. 53 shows a top view of an example of an inventive device.

FIG. 54 shows a bottom view of an inventive device according to FIG. 53.

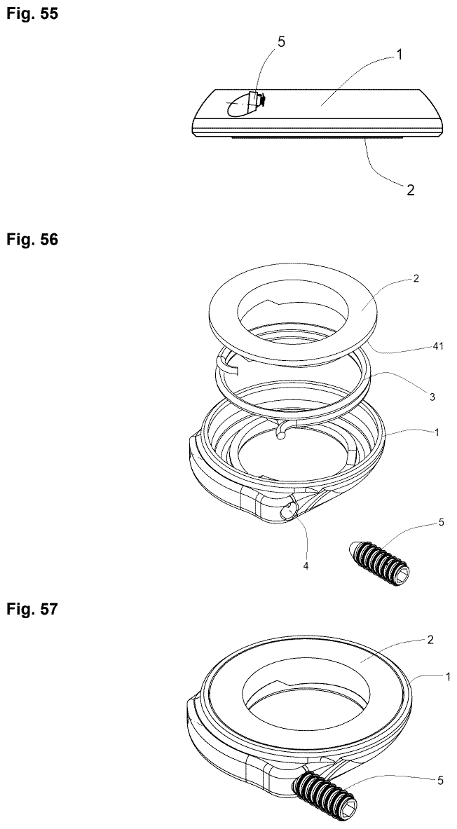

FIG. 55 shows a side view of the inventive device according to FIG. 53 in a tensioned state.

FIG. 56 shows a perspective bottom view of an exploded representation of various components of another implementation of an inventive device for adjusting a bearing play of components mounted in a coaxially rotatable manner relative to one another. The inventive device shown here may preferably be employed in hubs and corresponds in its basic structure to the embodiments represented in FIG. 1 and FIG. 21. The second part 2 has a wider edge 41 which acts as a spring retainer to secure the torsion spring 3.

FIG. 57 shows a perspective bottom view of the inventive device according to FIG. 56.

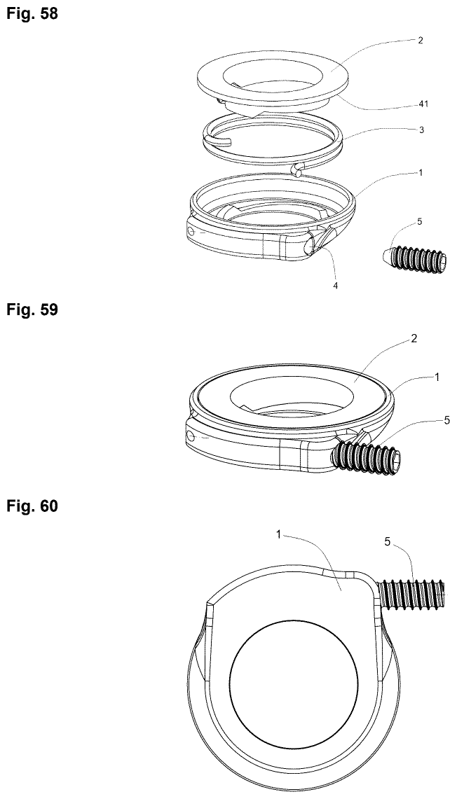

FIG. 58 shows another perspective bottom view of an exploded representation of the inventive device according to FIG. 56.

FIG. 59 shows a perspective bottom view of the inventive device according to FIG. 58.

FIG. 60 shows a top view of the inventive device according to FIG. 57.

FIG. 61 shows a top view of the inventive device according to FIG. 57 in which the second part 2 has been omitted.

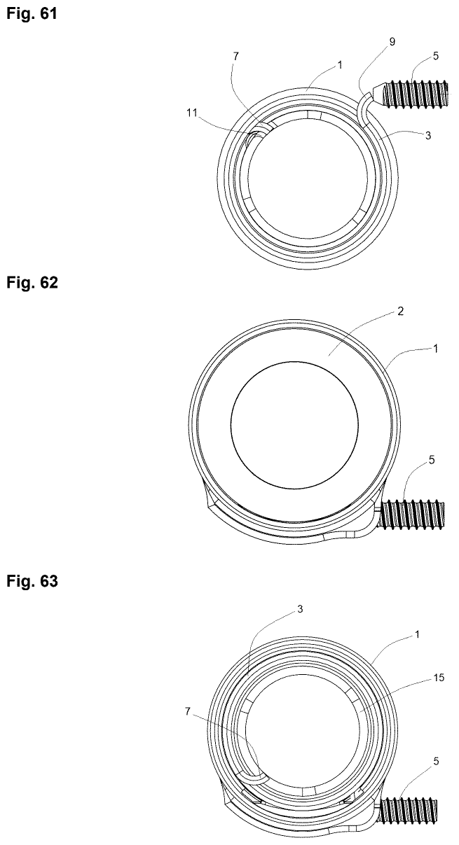

FIG. 62 shows a bottom view of the inventive device according to FIG. 57.

FIG. 63 shows a top view of the inventive device according to FIG. 57 in which the second part 2 has been omitted.

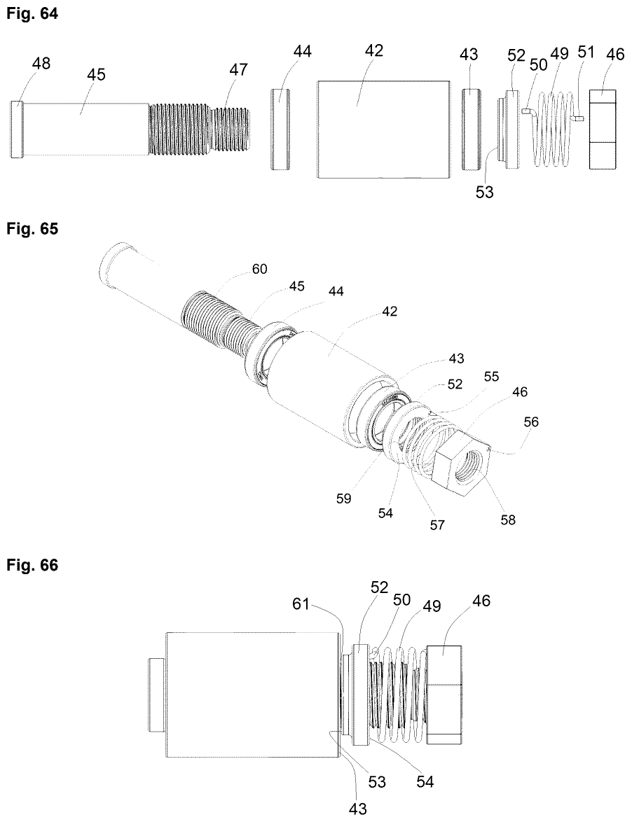

FIG. 64 shows a side view of an exploded representation of the components of a hub, more specifically a front wheel hub or a rear wheel hub in which another embodiment of an inventive device is employed for adjusting the bearing play. The hub has a hub body 42 and a hollow shaft 45 mounted in the hub body 42 by means of two bearings (e.g. rolling bearings), namely bearing 43 and bearing 44, which are preferably angular contact ball bearings. In the assembled condition, bearings 43 and 44 have been pressed into the hub body 42, with the hollow shaft 45 being connected to the inner rings of each bearing 43 and 44 via a sliding fit. The hollow shaft 45 is provided with an end cap on both sides, with the right-hand end cap, which is designed as a spring nut 46, being screwed onto the hollow shaft 45, which has a thread 47 provided for this purpose, and the left-hand end cap 48 being pressed or glued onto the hollow shaft 45. The spring nut 46 is part of the inventive device for adjusting a bearing play, which also includes a torsion spring 49 having a leg 50 and a leg 51, and a pressure ring 52 having a side 53 facing towards the bearings 43 and 44.

For the sake of clarity, in the case of a front wheel hub, the representation of a right and a left spoke flange arranged on the hub body 42 has been omitted. In the case of a rear wheel hub, the hub would additionally include a freehub body to which the hub body 42 is connected in a rotationally fixed manner, as well as a right and a left freehub body bearing.

The pressure ring 52 has a thread formed thereon and is screwed onto the hollow shaft 45 until there is no more play left within the system. The torsion spring 49 is hooked into the opening 55 formed in the pressure ring 52 and into the opening 56 formed in the spring nut 46. By screwing the spring nut 46 onto the hollow shaft 45, the spring end of the torsion spring 49, which is inserted into the spring nut 46, rotates around the hollow shaft 45, thereby twisting and pre-tensioning the torsion spring 49. Thus, a pre-tensioning force is applied. The spring nut 46 must be secured on the hollow shaft 45 against twisting or loosening by using non-illustrated means (e.g. lock nut, screw lock, split pin). As soon as play occurs in the system, the torque applied to the pressure ring 52 by the tensioned torsion spring 49 ensures that the pressure ring 52 automatically readjusts or rotates, thus ensuring a play-free system.

FIG. 65 shows a perspective view of the exploded representation according to FIG. 64. To accommodate the leg 50 of the torsion spring 49, the pressure ring 52, which has a side 54 which faces towards the spring nut 46 and may preferably be at least partially smooth and/or at least partially designed with at least one friction-increasing means, has an opening 55, which may be designed as a through hole or as a blind hole. An opening 56, which is arranged on the spring nut 46 and preferably passes through the spring nut 46 as a through-hole, although a blind hole design would also be conceivable, serves to accommodate the leg 51 of the torsion spring 49. It is conceivable that the side 57 of the spring nut 46 which faces towards the pressure ring 52 is at least partially smooth and/or at least partially designed with at least one friction-increasing means. The spring nut 46 has a thread 58 by which it can be screwed onto the hollow shaft 45, which has a thread 47 designed for this purpose. The pressure ring 52 has a thread 59 formed at least partially on its inner side by means of which it can be screwed onto the hollow shaft 45, which has a thread 60 designed for this purpose. It is also conceivable that the pressure ring 52 does not have a thread 59 on its inner side, so that it is only slid onto the hollow shaft 45, in which case the thread 60 could also be omitted. FIG. 66 shows a side view of an assembled hub according to FIG. 64 in an untensioned state. The leg 50 of the torsion spring 49 protrudes into the opening 55 of the pressure ring 52. In an untensioned state, the spring nut 46 is not yet tightened, so that a gap 61 is visible between the pressure ring 52 and the bearing 43 that has been pressed into the hub body 42.

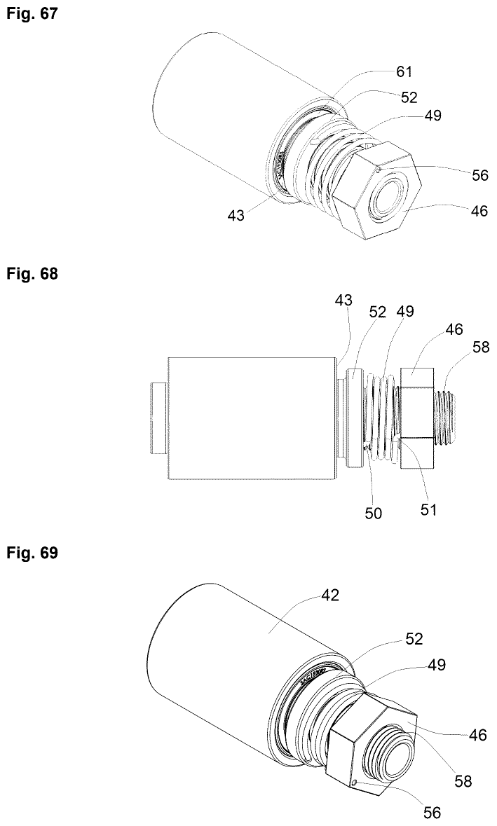

FIG. 67 shows a perspective view of the assembled hub according to FIG. 66 in an untensioned state. The leg 51 of the torsion spring 49 protrudes into the opening 56 of the spring nut 46.

FIG. 68 shows a perspective view of the assembled hub according to FIG. 66 in a tensioned state. The leg 50 of the torsion spring 49 protrudes into the opening 55 of the pressure ring 52. The leg 51 of the torsion spring 49 protrudes into the opening 56 of the spring nut 46. In a tensioned state, the spring nut is tightened, so that the pressure ring 52 of the inventive device 53 is applied to the bearing 53. A non-illustrated securing of the position of the spring nut 46 can be carried out in any conventional manner, for example by means of a lock nut or a split pin.

FIG. 69 shows a perspective view of the assembled hub according to FIG. 68 in a tensioned state.

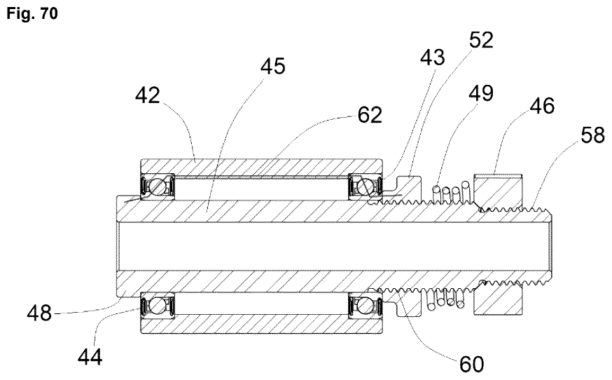

FIG. 70 shows the flow of forces 62 between the two bearings 43 and 44, which is represented as a black freehand line. All of the characteristics represented in the description, in the following claims and in the drawings, as considered either in themselves or in any combination with each other, may be deemed essential to the disclosure.

### LIST OF REFERENCE NUMBERS

1 first part
2 second part
3 torsion spring
4 drill hole
5 set screw
6 threaded insert
7 first leg
8 first stop
9 second leg
10 second stop
11 accommodation recess
12 opening
13 stop surface
14 side
15 contour
16 contour
17 recess
18 bracket
19 side
20 side
21 head tube
22 handlebar stem
23 fork shaft
24 bearing shell
25 bearing
26 clamping ring
27 bottom
28 bearing
29 bearing shell
30 spacer
31 flow of forces
32 underside
33 cover
34 pin
35 spring retainer
36 opening
37 surround wall
38 opening
39 pin
40 stop
41 edge
42 hub body
43 bearing
44 bearing
45 hollow shaft
46 spring nut
47 thread
48 end cap
49 torsion spring
50 leg
51 leg
52 pressure ring
53 side
54 side
55 opening
56 opening
57 side
58 thread
59 thread
60 thread
61 gap of forces
62 flow of forces

What is claimed is:

1. A device for adjusting a bearing play of components mounted in a coaxially rotatable manner relative to one another, the components being rotatably connected to each other by at least two bearings (25, 28) arranged at an axial distance from each other, wherein one of the components is received in an accommodation recess, the receiving recess being one of a housing, a bracket, a vehicle frame or a vehicle fork, and wherein the device comprises a side (19) or a side (20) to be able, in a direct or indirect manner, to be operatively connected coaxially to one of the two bearings (25, 28) and to exert axial pressure on the one of the bearings (25, 28), wherein the device further comprises a first part (1) provided with an opening (12) and having the side (20), and a second part, (2), wherein the first part (1) and the second part (2) are arranged coaxially on the component connected to the first accommodation recess, and further wherein the second part (2) has a side (14) which has at least one contour (16) protruding from a plane of the side (14) wherein the second part (2) protrudes at least partially into the opening (12) of the first part (1) so that the side (14) of the second part (2) at least partially contacts a stop surface (13) of the first part (1) located in the opening (12) which has a contour (15) protruding from the plane of the stop surface (13), wherein at least one of the contours (15, 16) is provided with a slope on which the at least one opposite contour (15, 16) slides, and wherein means are provided on the first part (1) and the second part (2) for mutual radial rotation as a result of which the second part (2) moves axially in the direction of the bearing (25, 28), and means for locking the axially moving second part (2) in an axial position it has assumed.

2. The device according to claim 1, wherein a torsion spring (3) is provided as the means for mutual radial rotation of the first part (1) and the second part (2), wherein the torsion spring includes a first stop (8) that at least partially protrudes into a second accommodation recess (11) arranged on the second part (2), and a second stop (10) that protrudes at least partially into a third accommodation recess (17) arranged on the first part (1), wherein an adjusting element, as the means for locking the second part (2), protrudes into the third accommodation recess (17) essentially tangentially or slightly obliquely, the adjusting element can be moved towards and locked against the second stop (10), or wherein, for mutual radial rotation of the first part (1) and the second part (2), one of the first or second parts (1,2) has a stop element protruding axially from its end face and the other of the first and second parts (1,2) has the recess (17) into which the stop element protrudes, wherein the adjusting element protrudes into the third accommodation recess (17) essentially tangentially or slightly obliquely, which adjusting element can be moved towards and locked against the stop element.

3. The device according to claim 2, wherein, when the torsion spring (3) is present, the torsion spring (3) has a first leg (7) directed at least partially towards the second accommodation recess (11) and a second leg (9) directed at least partially towards the third accommodation recess (17), with the first leg (7) at least partially forming the first stop (8) and/or the second leg (9) at least partially forming the second stop (10), or, if a stop element is present, the stop element is in the form of a pin (34).

4. The device according to claim 3, wherein, when the torsion spring (3) is present, the first leg (7) of the torsion spring (3), which at least partially forms the first stop (8), is secured by an axial locking device.

5. The device according to claim 4, wherein the axial locking device is arranged on the side (20) of the first part (1) and has a raised portion which protrudes at least partially into the third accommodation recess (17), or wherein the axial locking device is a groove arranged in the third accommodation recess (17) into which the first leg (1) protrudes at least partially, or wherein the axial locking device is a slot arranged on the third accommodation recess (17) through which the first leg (7) protrudes at least partially.

6. The device according to claim 2, wherein the adjusting element is a set screw (5).

7. The device according to claim 6, wherein the set screw (5) has a self-locking thread.

8. The device according to claim 1, wherein the first part (1) and/or the second part (2) comprise(s) a polymer material.

9. The device according to claim 1, wherein the second part (2) that, in an assembled state, faces away from the bearing (25, 28) is arranged on the component connected to the accommodation recess in an axially movable manner, with the second part (2) having an end face (19) that is applied to the accommodation recess of this component, with the accommodation recess forming an abutment for this second part (2).

10. A method of adjusting a bearing play of components mounted in a coaxially rotatable manner relative to one another, the components being rotatably connected to each other by at least two bearings (25, 28) arranged at an axial distance from each other by a device for adjusting the bearing play of the components mounted in the coaxially rotatable manner relative to one another, the components being rotatably connected to each other by the at least two bearings (25, 28) arranged at the axial distance from each other, wherein one of the components is received in an accommodation recess, the accommodation recess being one of a housing, a bracket, a vehicle frame or a vehicle fork, and wherein the device has a side in order to be able, in a direct or indirect manner, to be operatively connected coaxially to one of the two bearings (25, 28) and to exert axial pressure on one of the bearings (25, 28), wherein the device includes a first part (1) provided with an opening (12) and having the side (20), and a second part (2), the first and second parts being arranged coaxially on the component connected to the accommodation recess, wherein the second part (2) has a side (14) which has at least one contour (16) protruding from a plane of the side (14) wherein the second part (2) protrudes at least partially into the opening (12) of the first part (1) so that the side (14) at least partially contacts a stop surface (13) of the first part (1) located in the opening (12) which has a contour (15) protruding from the plane of the stop surface (13), wherein at least one of the contours (15, 16) is provided with a slope on which the at least one opposite contour (15, 16) slides, and wherein means are provided on the first part (1) and the second part (2) for mutual radial rotation as a result of which the second part (2) moves axially in the direction of the bearing (25, 28), and means for locking the axially moving second part (2) in an axial position it has taken, and means for locking the axially moving second part in the axial position taken, the method comprising: mechanically adjusting the bearing play by an operator, whereby a mutual relative radial rotation of the first part (1) and the second part (2) is affected due to a pre-tension provided during adjustment, causing the second part (2) to move axially.

11. The method according to claim 10, wherein the axial movement of a pressure ring causes automatic self-adjustment of the bearing play.

12. (canceled)

13. A device for adjusting a bearing play of components mounted in a coaxially rotatable manner relative to one another which are rotatably connected to each other by at least two bearings (43, 44) arranged at an axial distance from each other, wherein one component of the components is received in an accommodation recess, the accommodation recess being one of a housing, a bracket, a vehicle frame or a vehicle fork, and wherein the device has a side (53) to be able, in a direct or indirect manner, to be operatively connected coaxially to one of the at least two bearings (43, 44) and to exert axial pressure on the one of the at least two bearings (43, 44), wherein the device comprises a spring nut (46), a torsion spring (49) having a leg (50) and a leg (51), and a pressure ring (52), wherein the spring nut (46) has at least one opening (56) on one side (57) for at least partially receiving the leg (51) or at least one engaging piece for engaging the leg (51), and the pressure ring (52) has at least one opening (55) on one side (54) for at least partially receiving the leg (50) or at least one engaging piece for engaging the leg (50), and wherein the device is arranged coaxially on the component connected to the accommodation recess.

14. The device according to claim 13, wherein the pressure ring (52) has an inner surface that is at least partially smooth and/or that is at least partially provided with a thread (59).

15. The device according to claim 13, wherein the side (53) of the pressure ring (52) has at least partially at least one friction-increasing means and/or the side (54) of the pressure ring (52) has at least partially at least one friction-increasing means and/or the side (57) of the spring nut

(46) has at least partially at least one friction-increasing means.

16. The device according to claim 13, wherein at least one opening (55) is arranged in a groove arranged on the side (54) of the pressure ring (52), which has a center point, and/or at least one opening (56) is arranged in a groove arranged on the side (57) of the spring nut (46) which has a center point.

17. A method of adjusting a bearing play of components mounted in a coaxially rotatable manner relative to one another, the components being rotatably connected to each other by at least two bearings (43, 44) arranged at an axial distance from each other by a device for adjusting a bearing play of the components mounted in a coaxially rotatable manner relative to one another which are rotatably connected to each other by the at least two bearings (43, 44) arranged at the axial distance from each other, wherein one component of the components is received in an accommodation recess, the accommodation being one of a housing, a bracket, a vehicle frame or a vehicle fork, and wherein the device has a side (53) to be able, in a direct or indirect manner, to be operatively connected coaxially to one of the two bearings (43, and to exert axial pressure on the one of the bearings (43, 44), wherein the device comprises a spring nut (46), a torsion spring (49) having a leg (50) and a leg (51), and a pressure ring (52), wherein the spring nut (46), on one side (57), has at least one opening (56) for at least partially receiving the leg (51) or at least one engaging piece for engaging the leg (51), and the pressure ring (52), on one side (54), has at least one opening (55) for at least partially receiving the leg (50) or at least one engaging piece for engaging the leg (50), wherein the device is arranged coaxially on the component connected to the accommodation recess the method comprising mechanically adjusting the bearing play by an operator, whereby a mutual relative radial rotation of the spring nut (46) and the pressure ring (52) is affected due to a pre-tension provided during the adjustment, thus causing the pressure ring (52) to be able to move in an axial direction.

18. The method according to claim 17, wherein the axial movement of the pressure ring (52) causes automatic self-adjustment of the bearing play.

19. (canceled)
